(19) United States
(12) Patent Application Publication
(10) Pub. No.: US 2007/0287383 A1
(43) Pub. Date: Dec. 13, 2007

(54) WIRELESS COMMUNICATION APPARATUS AND TEMPERATURE COMPENSATION METHOD AND APPARATUS THEREOF

(75) Inventors: Kang-Wei Fan, Taipei (TW); Ching-Chung Tang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/761,380

(22) Filed: Jun. 12, 2007

(30) Foreign Application Priority Data
Jun. 12, 2006 (TW) 95120754

(51) Int. Cl. H04B 1/00; H04B 1/38

(52) U.S. Cl. 455/63.1; 455/73

(57) ABSTRACT

A wireless communication apparatus and a temperature compensation method thereof are provided. The method includes: providing a working power to the wireless communication apparatus; detecting a temperature of the wireless communication apparatus; deciding a function of working power versus wireless output power according the temperature; and adjusting the working power according the function of the working power versus the wireless output power and a wireless rated output power of the wireless communication apparatus.

### CROSS-REFERENCE TO RELATED APPLICATION

This application claims the priority benefit of Taiwan application serial no. 95120754, filed Jun. 12, 2006. All disclosure of the Taiwan application is incorporated herein by reference.

### BACKGROUND OF THE INVENTION

1. Field of the Invention

The present invention relates to a method and apparatus for saving power and improving efficiency for a wireless communication apparatus, and more particularly, to a wireless communication apparatus and a temperature compensation method and apparatus thereof.

2. Description of Related Art

In the 21^{st} century, a huge innovation we sense the most is the development of wireless communication. As the result of infinite expansion of wireless communication technology, people can enjoy more convenience in mobile communication. In the past few decades, as the super large integrated circuit technology has been developed actively, wireless communication has been widely applied in many fields. For example, the price and size of the current portable device of wireless telephone have been generally accepted by consumers.

FIG. 1 is a circuit block diagram of the main devices of a conventional wireless communication apparatus. Referring to FIG. 1, it comprises a transmitter/receiver 101, a power amplifier 102, an antenna 103 and a power supplier 104. The power supplier 104 is used to respectively supply the supply voltages VPA and TOLCV for the transmitter/receiver 101 and the power amplifier 102. FIG. 2 is the relationship of the supply voltages VPA and TOLCV in each section in normal temperature. Each section respectively represents the value of wireless output power. For example, the 1^{st} section represents that the output power is 0˜9 dbm, the 2^{nd} section represents that the output power is 9˜11 dbm, and the Nth section represents that the output power is 80˜100 dbm.

Conventionally, when the supply voltages (VPA and TOLCV) of a wireless communication apparatus are designed, first the supply voltages (VPA and TOLCV) are controlled according to the rated wireless output power, e.g. 10 dbm±1 dbm, of this wireless communication apparatus specified in the regulation and according to the above-mentioned FIG. 2, wherein the voltage value of TOLCV varies with the value of digital data received by the transmitter/receiver 101, and the voltage value of VPA varies with the voltage value of TOLCV according to the relationship in FIG. 2. Generally speaking, voltage is designed in the middle of a section, so that the wireless output power falls at, for example, 10 dbm±1 dbm. Generally, when the wireless output power is lower than the range of the rated wireless output power, signals of the wireless communication apparatus cannot be sent out. When the wireless output power is higher than the range of the rated wireless output power, signals of the wireless communication apparatus will interfere with other communication channels. Therefore, every country has very strict criterions on the range of wireless output power.

However, when temperature is changed, for example, when the environment temperature rises, the wireless output power is lowered; and when the environment temperature drops, the wireless output power is increased. The above-mentioned two situations are likely to cause a wireless communication apparatus not to pass authentication of each country. Further, it is very possible that communication cannot be performed or other communication channels are interfered.

### SUMMARY OF THE INVENTION

An objective of the present invention is to provide a temperature compensation method of a wireless communication apparatus for providing proper power supply according to the temperature of the wireless communication apparatus, so as to prevent the wireless communication apparatus from interfering with other communication channels.

Another objective of the present invention is to provide a wireless communication apparatus for reducing power consumption.

A further objective the present invention is to provide a temperature compensation apparatus of a wireless communication apparatus for improving the circuit operating efficiency.

The present invention provides a temperature compensation method of a wireless communication apparatus. The method comprises: providing a working power to the wireless communication apparatus; detecting a temperature of the wireless communication apparatus; deciding a function of the working power versus the output power according to the temperature; and adjusting the working power according to the function of the supply power versus the wireless output power and a wireless rated output power of the wireless communication apparatus.

In the temperature compensation method of a wireless communication apparatus according to a preferred embodiment of the present invention, the above-mentioned wireless communication apparatus comprises a transmitter/receiver and a power amplifier, and in the embodiment, the working power is a first voltage and a second voltage.

The present invention provides a temperature compensation apparatus of a wireless communication apparatus for performing temperature compensation to a wireless transceiver. The temperature compensation apparatus comprises a temperature sensor, a control circuit and an adjustable power supplier. The temperature sensor is used to detect a temperature of the transceiver and convert the temperature into a temperature signal. The control circuit receives the temperature signal and decides a function of the working power versus the output power according to the temperature signal. The adjustable power supplier supplies a working power to the wireless transceiver according to the function of the working power versus the output power and the wireless rated output power.

In the temperature compensation apparatus of a wireless communication apparatus according to a preferred embodiment of the present invention, the above-mentioned wireless transceiver comprises a transmitter/receiver and a power amplifier. The transmitter/receiver is coupled with the adjustable power supplier for receiving the first voltage of the working power. The power amplifier is coupled with the transmitter/receiver and the adjustable power supplier for receiving the second voltage of the working power. In the embodiment, the wireless transceiver further comprises an antenna.

The present invention provides a wireless communication apparatus. The apparatus comprises a wireless transceiver, a temperature sensor, a control circuit and an adjustable power supplier. The temperature sensor is used to detect a temperature of the transceiver and convert the temperature into a temperature signal. The control circuit receives the temperature signal and decides a function of the working power versus the output power according to the temperature signal. The adjustable power supplier supplies a working power to the wireless transceiver according to the function of the working power versus the output power and a wireless rated output power.

In the wireless communication apparatus according to a preferred embodiment of the present invention, the above-mentioned wireless transceiver comprises a transmitter/receiver and a power amplifier. The transmitter/receiver is coupled with the adjustable power supplier for receiving the first voltage of the working power. The power amplifier is coupled with the transmitter/receiver and the adjustable power supplier for receiving a second voltage of the working power. In the embodiment, the wireless transceiver further comprises an antenna.

As the present invention decides the function of the working power versus the output power according to temperature, adjusts the working power according to the function of the supply power versus the wireless output power and the wireless rated output power of the wireless communication apparatus, and provides a proper power supply to the circuit, thus, not only can the circuit operate at a rated wireless output power, but also the circuit power consumption is reduced and the circuit working efficiency is improved.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of the main devices of a conventional wireless communication apparatus.

FIG. 2 is the relationship of the supply voltages VPA and TOLCV in each section in normal temperature.

FIG. 3 is a circuit block diagram of a wireless communication apparatus according to an embodiment of the present invention.

FIG. 4 is a flow chart of a temperature compensation method according to an embodiment of the present invention.

FIG. 5 is a circuit block diagram of the wireless communication apparatus of the embodiment of the present invention comprising the temperature compensation apparatus of the embodiment of the present invention.

FIG. 6 is a diagram of the relationship between temperature and a function of the supply power versus the output power.

FIG. 7 is a flow chart of a temperature compensation method according to an embodiment of the present invention.

### DESCRIPTION OF EMBODIMENTS

In prior art, the temperature variation of a wireless communication apparatus causes drift of wireless output power, and in the prior art, two voltages TOLCV and VPA are changed only according to the transmitted digital data. When the environment temperature changes, situations like communication cannot be performed or other communication channels are interfered may easily occur. Therefore, the present invention provides a wireless communication apparatus and a temperature compensation apparatus and method thereof, so as to eliminate the above-mentioned problems, reduce power consumption and improve the circuit operating efficiency.

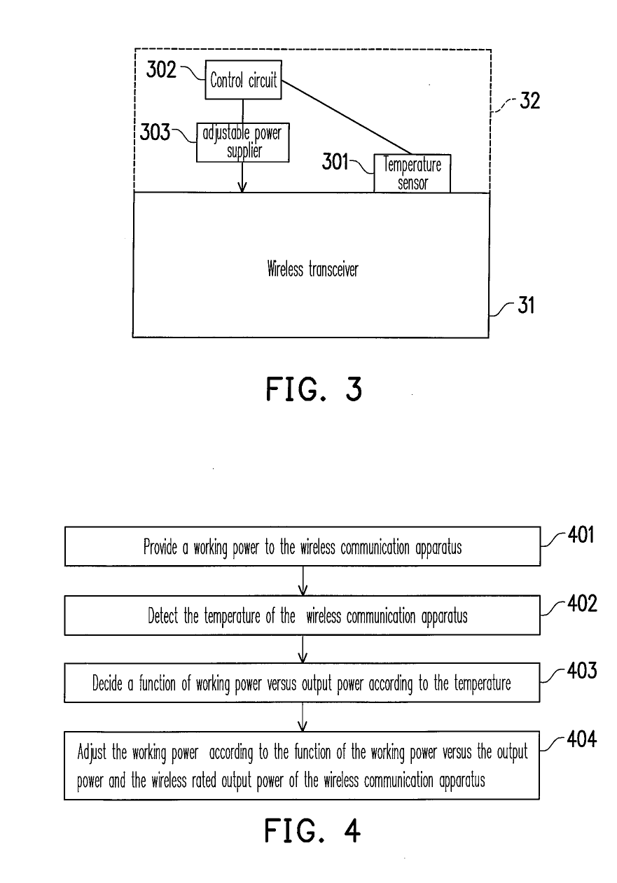

FIG. 3 is a circuit block diagram of a wireless communication apparatus according to an embodiment of the present invention. Referring to FIG. 3, the wireless communication apparatus comprises a wireless transceiver 31 and a temperature compensation apparatus 32 in the embodiment of the present invention. The temperature compensation apparatus 32 comprises a temperature sensor 301, a control circuit 302 and an adjustable power supplier 303. The temperature sensor 301 is used to detect a temperature of the wireless transceiver 31 and convert the temperature into a temperature signal. The control circuit 302 receives the temperature signal, and decides a function of the working power versus the output power according to the temperature signal. The adjustable power supplier 303 supplies a working power to the wireless transceiver according to the function of the working power versus the output power and a wireless rated output power.

FIG. 4 is a flow chart of a temperature compensation method according to an embodiment of the present invention. Referring to FIG. 4, in order to illustrate the spirit of the present invention, here, the apparatus in FIG. 3 is used to illustrate the flow steps of the temperature compensation method of the embodiment in FIG. 4 of the present invention. Referring to FIGS. 3 and 4 at the same time, first, a working power is provided to the wireless communication apparatus (step 401). Next, the temperature sensor 301 is used to detect the temperature of the wireless communication apparatus, for example, the temperature of the above-mentioned wireless transceiver 31 (step 402). A function of the working power versus the output power is decided according to the temperature (step 403). Finally, the working power is adjusted according to the function of the working power versus the output power and the wireless rated output power of the wireless communication apparatus (step 404).

It should be noted that, although a possible configuration has been described for the wireless communication apparatus and the temperature compensation method and apparatus in the above-mentioned embodiments, those skilled in the art should appreciate that different manufacturers have different design manners for the control circuit 302, thus the applications of the present invention should not be limited to this possible configuration. In other words, as long as the control circuit 302 decides the function of the working power versus the output power according to temperature, and adjusts the working power according to the function of the supply power versus the output power and the wireless rated output power of the wireless communication apparatus, it falls within the spirit of the present invention.

Next, several embodiments are provided for those skilled in the art to easily implement the present invention.

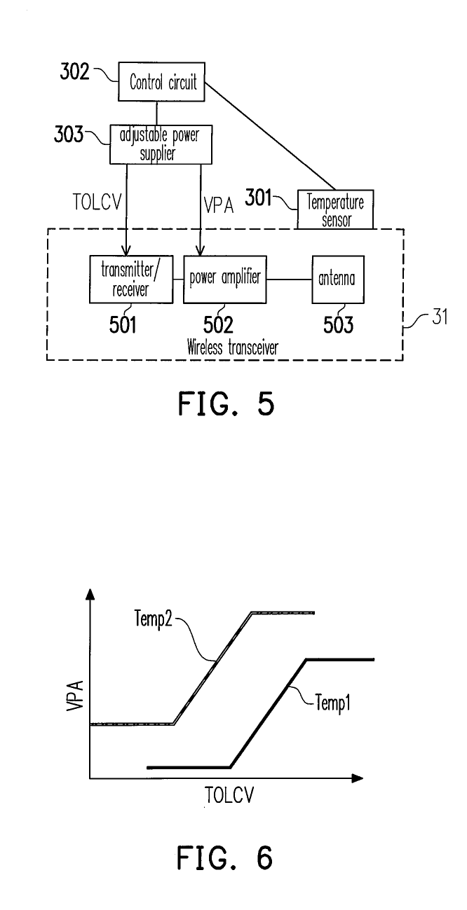

FIG. 5 is a circuit block diagram of the wireless communication apparatus of the embodiment of the present invention comprising the temperature compensation apparatus of the embodiment of the present invention. Referring to FIG. 5, the wireless transceiver 31 is implemented with a transmitter/receiver 501, a power amplifier 502 and an antenna 503. The transmitter/receiver 501 and the power amplifier 502 respectively receive a first voltage TOLCV and a second voltage VPA of the working power. Next, referring to FIG. 6, a diagram of the relationship between the temperature and a function of the supply power versus the output power is shown. Corresponding to FIG. 2, the X axis is TOLCV, and the Y axis is VPA. According to FIG. 6, it can be seen that, in the situation of considering the best power consumption, when temperature changes, the relationship of TOLCV and VPA should change with temperature. For example, temp1 of FIG. 6 represents a function of the supply power versus the output power in normal temperature (20˜30 degrees), and temp 2 represents a function of the supply power versus the output power in high temperature (40˜60 degrees).

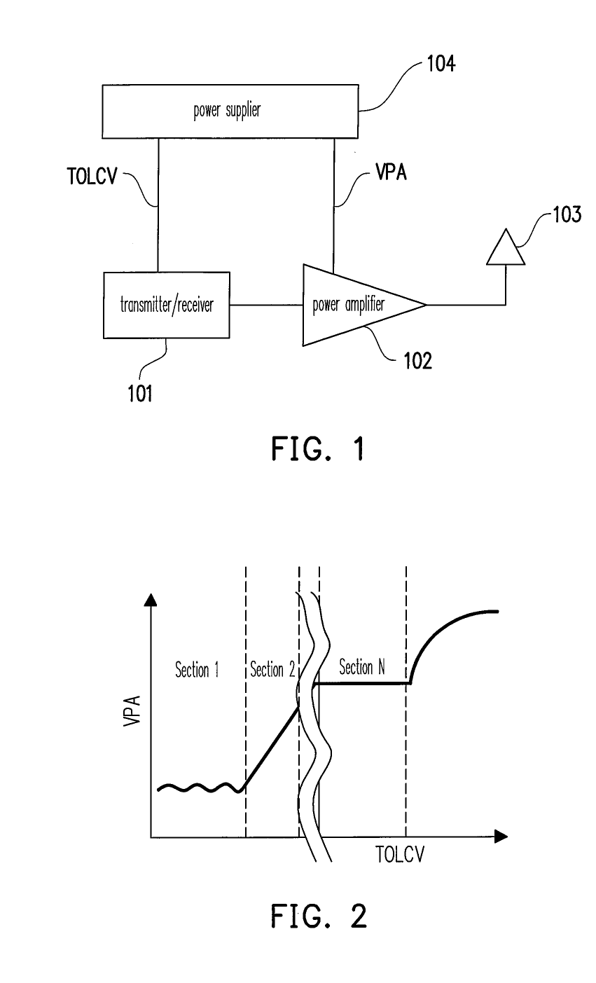

Therefore, the above-mentioned temperature sensor 301 senses the temperature of the transmitter/receiver 501 and the power amplifier 502, and transmits the temperature signal to the control circuit 302. The control circuit 302 calculates the function of the working power versus the output power according to the temperature signal (for example, shift operation in FIG. 6, however, FIG. 6 is only used for illustrating the embodiment and it should be appreciated that the present invention may still use the temperature signal as a variable to store the function in a Look-Up Table and output the function according to the temperature signal). Next, the adjustable power supplier 303 respectively supplies voltages TOLCV and VPA to the transmitter/receiver 501 and the power amplifier 502 according to the function of the working power versus the output power and the wireless rated output power, according to the conventional manner as shown in FIG. 1, and according to the digital data value received by the transmitter/receiver 501.

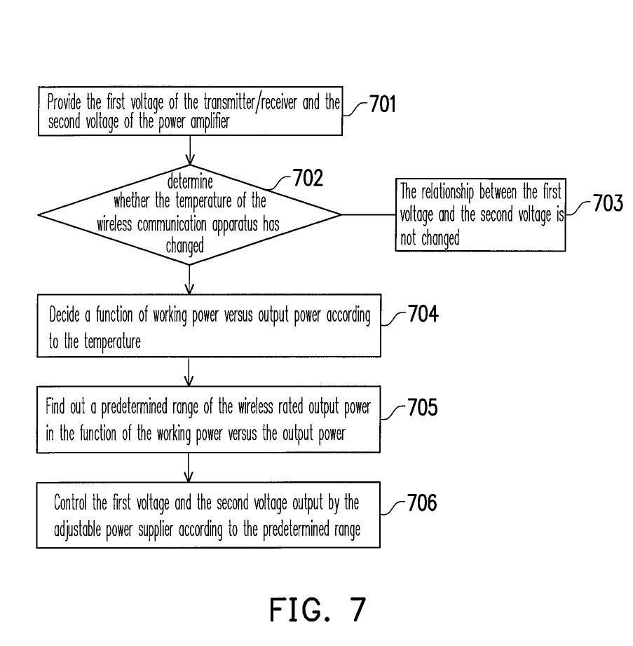

FIG. 7 is a flow chart of a temperature compensation method according to an embodiment of the present invention. Referring to FIG. 7, here, the apparatus of FIG. 5 is used to illustrate the flow steps of the temperature compensation method in the embodiment of FIG. 7 of the present invention. First, a first voltage TOLCV and a second voltage VPA of the transmitter/receiver 501 and the power amplifier 502 are respectively provided to the control circuit 302 (step 701). Next, it is determined whether the temperature of the wireless communication apparatus has changed (step 702). When the temperature has not changed, the relationship between the first voltage and the second voltage is not changed (step 703). When the temperature has changed, a function of the working power versus the output power is decided according to the temperature (step 704). A predetermined range of wireless rated output power is found in the function of the working power versus the output power, for example, when a mobile phone operates at 10 dbm±1 dbm, it must operate at the section 9˜11 dbm in the function of the working power versus the output power (step 705). Finally, the first voltage TOLCV and the second voltage VPA output by the adjustable power supplier are controlled according to this predetermined range (step 706).

In summary, as the present invention decides the function of the working power versus the output power according to temperature, adjusts working power according to the function of the working power versus the output power and the wireless rated output power of the wireless communication apparatus, and provides a proper power supply to the circuit, thus, not only can the circuit operate at a rated wireless output power, but also the circuit power consumption is reduced and the circuit working efficiency is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A temperature compensation method of a wireless communication apparatus, comprising:
detecting a temperature of the wireless communication apparatus;
deciding a function of working power versus output power according to the temperature; and
dynamically adjusting the working power according to the function of the working power versus the output power and a wireless rated output power of the wireless communication apparatus.

2. The temperature compensation method of a wireless communication apparatus as claimed in claim 1, wherein the working power is voltage.

3. The temperature compensation method of a wireless communication apparatus as claimed in claim 1, wherein the step of providing the working power to the wireless communication apparatus further comprises:
supplying a first voltage and a second voltage of a transmitter/receiver and a power amplifier respectively with an adjustable power supplier.

4. The temperature compensation method of a wireless communication apparatus as claimed in claim 3, wherein the step of dynamically adjusting the working power according to the function of the working power versus the output power and the wireless rated output power of the wireless communication apparatus comprises:
finding out a predetermined range of the wireless rated output power in the function of the working power versus the output power; and
controlling the first voltage and the second voltage output by the adjustable power supplier according to the predetermined range.

5. A temperature compensation apparatus of a wireless communication apparatus, for performing temperature compensation to a wireless transceiver, comprising:
a temperature sensor, for detecting a temperature of the wireless transceiver, and converting the temperature into a temperature signal;
a control circuit, coupled with the temperature sensor, for receiving the temperature signal and deciding a function of working power versus output power according to the temperature signal; and
an adjustable power supplier, coupled with the wireless transceiver and the control circuit, for supplying a working power to the wireless transceiver according to the function of the working power versus the output power and a wireless rated output power.

6. The temperature compensation apparatus of a wireless communication apparatus as claimed in claim 5, wherein the wireless transceiver comprises:
a transmitter/receiver, coupled with the adjustable power supplier, for receiving a first voltage of the working power; and
a power amplifier, coupled with the transmitter/receiver and the adjustable power supplier, for receiving a second voltage of the working power.

7. The temperature compensation apparatus of a wireless communication apparatus as claimed in claim 6, wherein the wireless transceiver further comprises an antenna.

8. A wireless communication apparatus, comprising:
a wireless transceiver;
a temperature sensor, for detecting a temperature of the wireless transceiver, and converting the temperature into a temperature signal;
a control circuit, coupled with the temperature sensor, for receiving the temperature signal and deciding a function of working power versus output power according to the temperature signal; and
an adjustable power supplier, coupled with the wireless transceiver and the control circuit, for supplying a working power to the wireless transceiver according to the function of the working power versus the output power and a wireless rated output power.

9. The wireless communication apparatus as claimed in claim 8, wherein the wireless transceiver comprises:
a transmitter/receiver, coupled with the adjustable power supplier, for receiving a first voltage of the working power; and
a power amplifier, coupled with the transmitter/receiver and the adjustable power supplier, for receiving a second voltage of the working power.

10. The wireless communication apparatus as claimed in claim 9, wherein the wireless transceiver further comprises an antenna.
